(19) United States
(12) Patent Application Publication
(10) Pub. No.: US 2022/0138585 A1
(43) Pub. Date: May 5, 2022

(54) SYSTEMS AND METHODS FOR APPLYING A LENS FUNCTION GENERATED USING SUPERVISED LEARNING TECHNIQUES TO SEGMENT DATA PROVIDED TO AN UNSUPERVISED LEARNING MODEL

(71) Applicant: ConcertAI, LLC, Boston, MA (US)

(72) Inventor: Samuel Peter Heilbroner, New York, NY (US)

(21) Appl. No.: 17/515,275

(22) Filed: Oct. 29, 2021

Related U.S. Application Data
(60) Provisional application No. 63/108,165, filed on Oct. 30, 2020.

(51) Int. Cl. G06N 3/08; G06K 9/62

(52) U.S. Cl. CPC G06N 3/088; G06K 9/6296; G06K 9/6259; G06K 9/6218

(57) ABSTRACT

Systems and methods for generating a lens function using supervised learning techniques are disclosed. The systems and methods described herein can utilize labeled training data having a first dimensionality to train a model comprising a plurality of layers. At least one of the layers of the model can be a bottleneck layer. After training the model with labeled training data, weight values can be extracted from the one or more neurons in the bottleneck layer. The weight values can be used to generate one or more lens functions for an unsupervised learning technique. The lens functions can accurately calculate segmentation information for unlabeled data having the first dimensionality, such that relevant information is preserved for unsupervised learning and irrelevant information is does not affect analysis after segmentation.

### CROSS-REFERENCE TO RELATED APPLICATIONS

The present application claims the benefit of and priority to U.S. Provisional Application No. 63/108,165, entitled “SYSTEMS AND METHODS FOR APPLYING A LENS FUNCTION GENERATED USING SUPERVISED LEARNING TECHNIQUES TO SEGMENT DATA TO AN UNSUPERVISED LEARNING MODEL,” filed Oct. 30, 2020, the content of which is hereby incorporated by reference in its entirety for all purposes.

### BACKGROUND

Unsupervised learning techniques can be used to analyze patterns or relationships present in large datasets. One type of unsupervised learning technique includes clustering data points in a dataset to identify said patterns or relationships. However, it can be challenging to cluster or segment the data in a dataset in a way that produces a desired output.

### SUMMARY

Unsupervised learning techniques are used to derive inferences from datasets consisting of unlabeled input data. One type of unsupervised learning method is cluster analysis, which is used for exploratory data analysis to find hidden patterns or grouping in data. However, one of the challenges with unsupervised learning techniques, and in particular, with unsupervised learning techniques that process data having a large number of features, is the ability to generate clusters that are meaningful for gleaning insights from the data. Simply stated, unsupervised learning techniques may not identify meaningful correlations between the input data and the clusters (or outcomes) generated from the data. For instance, unsupervised learning techniques may not be able to identify a cluster of patients that are likely to experience an adverse reaction to a particular drug as the unsupervised learning techniques are unable to identify which parameters or features of the input data correspond or contribute to the adverse reaction of the drug.

Conventional unsupervised learning techniques that employ topological data analysis may require manual specification and tuning of lens functions based on heuristics to provide meaningful output. These lenses are often selected from a list of pre-defined functions that do not change from analysis. However, finding the correct lens manually can be slow and provide inconsistent results across different datasets. In some cases, pre-defined lenses may not accurately capture any meaningful patterns in the data. To address the deficiencies in unsupervised learning techniques, the present disclosure relates to applying a lens function generated using supervised learning techniques to segment input data provided to an unsupervised learning model to satisfy a desired request to segment or cluster the input data. The systems and methods of this technical solution resolve these issues by using supervised learning techniques to compute a lens function that can be applied to an unsupervised learning model to segment input data provided to the unsupervised learning model. To do so, the systems and methods described herein can utilize a supervised model, such as a multi-layer-perceptron (MLP) neural network, with an embedded bottleneck layer. Each layer in a neural network can process and propagate input information to the next layer in the network. Relying on these properties, a bottleneck layer, which can be a layer in a neural network that has fewer neurons (sometimes referred to as a “node”) than other layers (e.g., forming a “bottleneck”), can be inserted in the neural network to reduce the dimensionality of data in the network to a desired number. As no layer in the neural network utilizes any more information than is provided by a previous layer, a bottleneck layer can serve to isolate, or reduce, information in a previous layer to only what is relevant for computing a desired output. Once a neural network containing a bottleneck layer is trained, the systems and methods of this technical solution can extract weights, biases, structural information, or other information from the bottleneck layer, and from any other layers preceding the bottleneck layer, to generate lens functions for unsupervised learning techniques such as Ayasdi. This process solves the issues identified above with respect to heuristic lens functions, and can be used on any type of input data to predict any desired relationship between items in a dataset.

At least one aspect of the present disclosure relates to a method for generating a lens function using supervised learning techniques. The method can include maintaining, in a database, labeled training data having a first dimensionality. The method can include training, using a supervised learning technique and the labeled training data, a model including a plurality of layers. The plurality of layers can include an input layer having the first dimensionality and a bottleneck layer having one or more bottleneck neurons. The method can include extracting, responsive to training the model, weight values from the one or more bottleneck neurons. The method can include generating one or more lens functions using the weight values extracted from the one or more bottleneck neurons. The method can include calculating segmentation information for unlabeled data having the first dimensionality using the one or more lens functions.

In some implementations, the method can include storing, in one or more data structures, a mapping between the unlabeled data and the segmentation information. In some implementations, the method can include generating a directed graph using the mapping between the unlabeled data and the segmentation information. In some implementations, generating the directed graph can include applying a clustering algorithm to segmentation information to indicate relationships between groups of the unlabeled data. In some implementations, training the model can include updating the plurality of layers based on a backpropagation algorithm.

In some implementations, training the model can include determining an accuracy of the model. In some implementations, training the model can include terminating training of the model responsive to the accuracy of the model satisfying a predetermined threshold. In some implementations, extracting the weight values from the one or more bottleneck neurons can include storing the weight values in one or more data structures in memory of the data processing system. In some implementations, the one or more lens can include one or more bias values. In some implementations, extracting the weight values from the one or more bottleneck neurons can include extracting one or more bias values from the bottleneck neurons.

In some implementations, extracting the weight values from the one or more bottleneck neurons can include extracting additional weight values from at least one layer following the bottleneck layer. In some implementations, generating the one or more lens functions is based on the additional weight values extracted from the at least one layer following the bottleneck layer.

At least one other aspect of the present disclosure is directed to another method. The method can include maintaining one or more lens functions generated based on weight values extracted from a model trained using a supervised learning technique. The method can include receiving unlabeled data for use in an unsupervised learning technique. The method can include calculating segmentation information for the unlabeled data.

In some implementations, the method can include storing, in one or more data structures, a mapping between the unlabeled data and the segmentation information. In some implementations, the method can include generating a directed graph using the mapping between the unlabeled data and the segmentation information. In some implementations, generating the directed graph further comprises applying a clustering algorithm to segmentation information to indicate relationships between groups of the unlabeled data.

At least one other aspect of the present directed to another method. The method can include maintaining labeled training data having a first dimensionality. The method can include maintaining, in a database, labeled training data having a first dimensionality. The method can include training, using a supervised learning technique and the labeled training data, a model including a plurality of layers. The plurality of layers can include an input layer having the first dimensionality and a bottleneck layer having one or more bottleneck neurons. The method can include extracting, responsive to training the model, weight values from the one or more bottleneck neurons. The method can include generating one or more lens functions using the weight values extracted from the one or more bottleneck neurons.

In some implementations, training the model can include updating the plurality of layers based on a backpropagation algorithm. In some implementations, training the model can include determining an accuracy of the model. In some implementations, training the model can include terminating training of the model responsive to the accuracy of the model satisfying a predetermined threshold. In some implementations, extracting the weight values from the one or more bottleneck neurons can include storing the weight values in one or more data structures in memory of the data processing system.

In some implementations, the one or more lens can include one or more bias values. In some implementations, extracting the weight values from the one or more bottleneck neurons can include extracting one or more bias values from the bottleneck neurons. In some implementations, extracting the weight values from the one or more bottleneck neurons can include extracting additional weight values from at least one layer following the bottleneck layer. In some implementations, generating the one or more lens functions is based on the additional weight values extracted from the at least one layer following the bottleneck layer. In some implementations, the method can include calculating segmentation information for unlabeled data using the one or more lens functions.

At least one other aspect of the present disclosure is directed to a system. The system can include a data processing system comprising one or more processors coupled to memory. The system can maintain labeled training data having a first dimensionality. The system can train, using a supervised learning technique and the labeled training data, a model comprising a plurality of layers. The plurality of layers can include an input layer having the first dimensionality and a bottleneck layer having one or more bottleneck neurons. The system can extract, responsive to training the model, weight values from the one or more bottleneck neurons. The system can generate one or more lens functions based on the weight values extracted from the one or more bottleneck neurons. The system can calculate segmentation information for unlabeled data using the one or more lens functions.

In some implementations, the system can store, in one or more data structures, a mapping between the unlabeled data and the segmentation information. In some implementations, the system can generate a directed graph using the mapping between the unlabeled data and the segmentation information. In some implementations, to generate the directed graph, the system can apply a clustering algorithm to segmentation information to indicate relationships between groups of the unlabeled data.

In some implementations, to train the model, the system can update the plurality of layers based on a backpropagation algorithm. In some implementations, train the model, the system can determine an accuracy of the model, and terminate training of the model responsive to the accuracy of the model satisfying a predetermined threshold. In some implementations, to extract the weight values from the one or more bottleneck neurons, the system can store the weight values in one or more data structures in memory of the data processing system. In some implementations, the one or more lens functions comprise one or more bias values. In some implementations, to extract the weight values from the one or more bottleneck neurons, the system can extract one or more bias values from the bottleneck neurons.

In some implementations, to extract the weight values from the one or more bottleneck neurons, the system can extract additional weight values from at least one layer following the bottleneck layer. In some implementations, the system can generate the one or more lens functions further based on the additional weight values extracted from the at least one layer following the bottleneck layer.

At least one other aspect of the present disclosure is directed to another system. The system can include one or more processors coupled to memory. The system can maintain one or more lens functions generated based on weight values extracted from a model trained using a supervised learning technique. The system can receive unlabeled data for use in an unsupervised learning technique. The system can calculate segmentation information for the unlabeled data.

In some implementations, the system can store, in one or more data structures, a mapping between the unlabeled data and the segmentation information. In some implementations, the system can generate a directed graph using the mapping between the unlabeled data and the segmentation information.

In some implementations, to generate the directed graph, the system can apply a clustering algorithm to segmentation information to indicate relationships between groups of the unlabeled data.

At least one of other aspect of the present disclosure is directed to another system. The system can include a data processing system comprising one or more processors coupled to memory. The system can train, using a supervised learning technique and the labeled training data, a model comprising a plurality of layers. The plurality of layers can include an input layer having the first dimensionality and a bottleneck layer having one or more bottleneck neurons. The system can extract, responsive to training the model, weight values from the one or more bottleneck neurons. The system can generate one or more lens functions based on the weight values extracted from the one or more bottleneck neurons.

In some implementations, to train the model, the system can update the plurality of layers based on a backpropagation algorithm. In some implementations, train the model, the system can determine an accuracy of the model, and terminate training of the model responsive to the accuracy of the model satisfying a predetermined threshold. In some implementations, to extract the weight values from the one or more bottleneck neurons, the system can store the weight values in one or more data structures in memory of the data processing system. In some implementations, the one or more lens functions comprise one or more bias values. In some implementations, to extract the weight values from the one or more bottleneck neurons, the system can extract one or more bias values from the bottleneck neurons.

In some implementations, to extract the weight values from the one or more bottleneck neurons, the system can extract additional weight values from at least one layer following the bottleneck layer. In some implementations, the system can generate the one or more lens functions further based on the additional weight values extracted from the at least one layer following the bottleneck layer. In some implementations, the system can calculate segmentation information for unlabeled data using the one or more lens functions.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates general representations of various supervised learning techniques, in accordance with illustrative embodiments;

FIG. 2 illustrates an example data cluster resulting from an unsupervised learning technique, in accordance with an illustrative embodiment;

FIGS. 3 and 4 illustrate a comparison between the segmentation of a dataset for use in an unsupervised learning technique using different lens functions, in accordance with an illustrative embodiment;

FIG. 5 illustrates a block diagram of an example system for generating a lens function using a supervised learning technique, in accordance with an illustrative embodiment;

FIG. 6 illustrates an example neural network including a bottleneck layer, in accordance with an illustrative embodiment

FIG. 7 illustrates an example data-flow diagram of the generation of lens functions using a supervised learning technique, in accordance with an illustrative embodiment;

FIG. 8 illustrates an example flow diagram of a method for generating a lens function using a supervised learning technique, in accordance with an illustrative embodiment; and

FIG. 9 is a block diagram of a server system and a client computer system in accordance with an illustrative embodiment.

### DETAILED DESCRIPTION

Below are detailed descriptions of various concepts related to and implementations of, techniques, approaches, methods, apparatuses, and systems for generating a lens function using supervised learning techniques. The various concepts introduced above and discussed in detail below may be implemented in any of numerous ways, as the described concepts are not limited to any particular manner of implementation. Examples of specific implementations and applications are provided primarily for illustrative purposes.

The present techniques can utilize supervised learning techniques to train lens functions for unsupervised learning techniques that implement topological data analysis, such as Ayasdi. To do so, a supervised learning technique can be used to train a supervised model to predict a desired outcome or characteristic. A bottleneck layer can be inserted in the supervised model at a layer position following the input layer. The bottleneck layer can reduce the information provided at the input layer to only the information that is necessary to predict the desired output. The neural network, including the bottleneck layer, can be trained such that the neural network can classify or predict the desired output accurately. After training, the weights, biases, structure, or other information from the bottleneck layer, and the layers preceding the bottleneck layer, can be extracted and used to generate a lens function for use in an unsupervised learning environment. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

For the purposes of understanding the organization of this specification, the following section descriptions may be helpful:

Section A describes the generation of lens functions using supervised learning techniques; and

Section B describes a network environment and computing environment, which may be useful for practicing various embodiments described herein.

### A. Generation of Lens Functions Using Supervised Learning Techniques

Prior to describing implementations of the systems and methods of this technical solution, it may be help to provide a brief overview of supervised and unsupervised learning techniques.

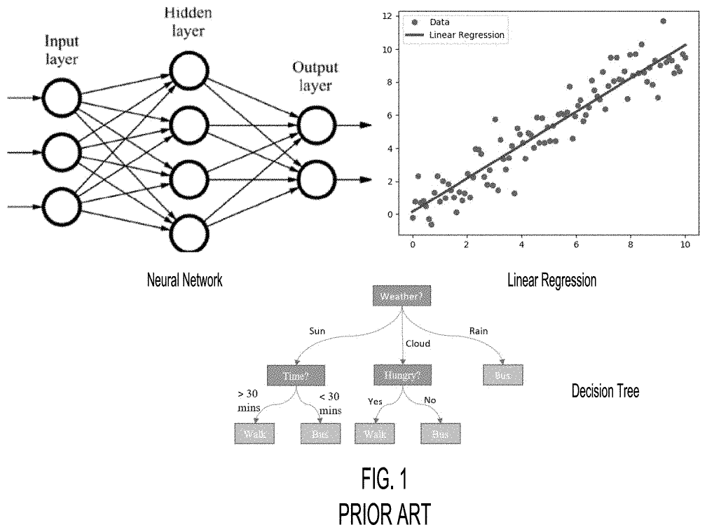

Referring now to FIG. 1, depicted are various types of supervised learning techniques. One such technique includes a sequential neural network, which can include one or more layers of neurons. Each neuron in a neural network, such as the neural network depicted in FIG. 1, can include weights, biases, or other values that transform input values (e.g., depicted as arrows pointing into a neuron, etc.) into an output value (e.g., depicted as an arrow pointing out of the neuron, etc.). In some implementations, the input values for a neuron can include all of the output values of the neurons in the previous layer. The output value of a neuron can be provided to the inputs of each neuron in the following layer, until a final output neuron is reached. Thus, in some implementations, a neural network can be a sequential neural network, where the output of each layer feeds into an input of the next layer. This can also be referred to as a “feed-forward network”. The feed-forward network depicted in FIG. 1 can also be called a “multi-layer perceptron” network. Although a feed-forward neural network is depicted in FIG. 1, it should be appreciated that other neural network types may be used in conjunction with the systems and methods described herein to generate lens functions for unsupervised learning algorithms.

For example, one other type of neural network can be a type of recurrent neural network. A recurrent neural network is a class of neural networks where the connections between neurons form a directed graph over a sequence, where previous inputs affect the outputs to neurons. In some implementations, memory values (e.g., an output from a neuron) can be stored within a neuron, and used as an input value to the neuron when computing its respective output value. In some implementations, the outputs of neurons in later layers are fed-back as inputs to earlier layers. One type of a recurrent neural network is a long short-term memory (LSTM) network. Another, more general, type of a recurrent neural network is a neural network comprising gated recurrent units (GRUs).

Neural networks, such as the multi-layer perceptron network, can be trained using labeled training data in a supervised learning process. The labeled training data can include input information, which can be encoded to match the input dimensions of the neural network, and a label that describes an attribute of the input data. For example, the attribute can be a classification, such as a binary classification, of the input data. By using the supervised learning techniques described herein, the weights and biases of a supervised model, such as a neural network, can be adjusted based on known, or labeled, input data, with the goal being that when presented with new or unlabeled input data, the neural network will output an accurate classification or prediction.

Another supervised learning technique is linear regression. Linear regression algorithms can be machine-learning techniques that are used for classification of input data into one or more groups. A linear regression model, or a linear classifier, can determine a classification decision (e.g., whether the input data belongs to a particular group) based on a value of a linear combination of the characteristics of the input data. The input data can sometimes be referred to as feature data. Linear classifiers can be utilized when classification speed is a priority over classification accuracy. However, linear classifiers tend to be more accurate when the input data has a high dimensionality. Another supervised learning technique is a decision tree model, which can utilize various decision nodes and terminal nodes to classify a portion of the input data. A training algorithm can adjust weights and other coefficients of the decision nodes in a decision tree model to classify input data accurately. Each potential classification of the input data can correspond to a terminal node in the decision tree.

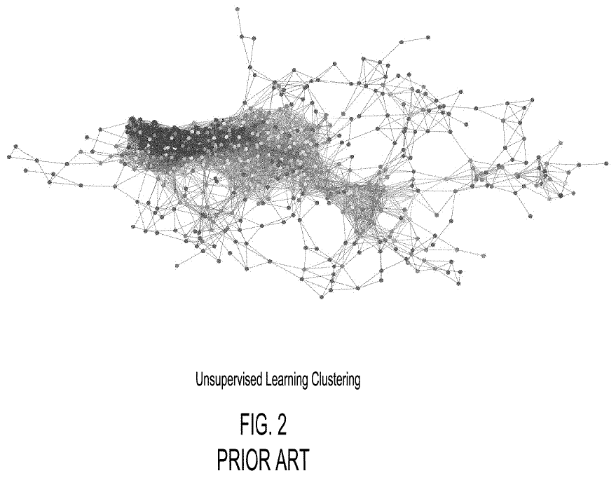

Referring now to FIG. 2, illustrated is an example data cluster resulting from an output of an unsupervised learning model. Unlike the supervised learning techniques described herein above, unsupervised learning techniques may not utilize known or labeled data to identify patterns in data. Instead of training a model to achieve a particular goal, such as the classification of input information, unsupervised learning techniques are utilized to analyze patterns that are present in datasets. Those patterns then be used to identify correlations or make predictions about other, similar input data. One type of output of unsupervised learning techniques, as depicted in FIG. 2, is a graph of the input data, which may include clusters of data points. Unsupervised learning techniques can be used to determine or visualize how the input data is distributed with respect to other data items in the dataset, or if there are any clusters or outliers in the dataset.

One potential weakness of unsupervised learning techniques is that they often detect patterns that are not related to a target problem. For example, consider a patient recently diagnosed with non-small cell lung cancer (NSCLC), with a medical history including hypertension, type 2 diabetes, and osteoarthritis. Each of those items of medical history may present a significant source of variation in the clustering of data when presented to an unsupervised learning algorithm, such as Ayasdi. However, patterns influenced by those factors may wash out other statistics related to NSCLC progression. Put simply, in unsupervised algorithms such as Ayasdi, the strongest signal, or source of variation, will likely wash out other signals of interest.

Topological data analysis (TDA) is a class of unsupervised learning techniques that uses data shape to make predictions and derive insights. Ayasdi is one type of TDA, which allows for the visualization of high dimensional data on a two-dimensional plot, as depicted in FIG. 2. In the process of simplifying the data, the Ayasdi can make choices about which patterns to represent and which to ignore. However, Ayasdi may not represent target patterns, or patterns of interest. To represent target patterns, lens functions can be used to segment the data in a way that ignores information about the input data that is irrelevant to the target pattern or output. Thus, with a proper lens function, Ayasdi, or other types of unsupervised learning techniques, can represent the pattern of interest in a desired way.

The Ayasdi algorithm can include assigning a real value or vector to each input data point based on a mapper function (referred to herein as a “lens function” or a “lens”). Next, the data can be binned, or segmented into various coordinates, using the lens function. The data points in each segment can then be clustered into nodes. When segmenting the bins for the Ayasdi algorithm, some data points can overlap, or belong to more than one bin. To represent the clustered data in graph form, the cluster node pairs that have overlapping data can be connected, or linked, with an edge to generate a bipartite graph. This bipartite graph can then be represented (e.g., visually on a display, etc.) in two dimensions. The amount of overlap occurring in each segment can be modified using a hyper-parameter called the gain. The bins in are designed to overlap slightly with each other (based on the gain) so that a single data point can be in multiple nodes. Two nodes are adjacent, or connected by an edge, if they share at least one data point.

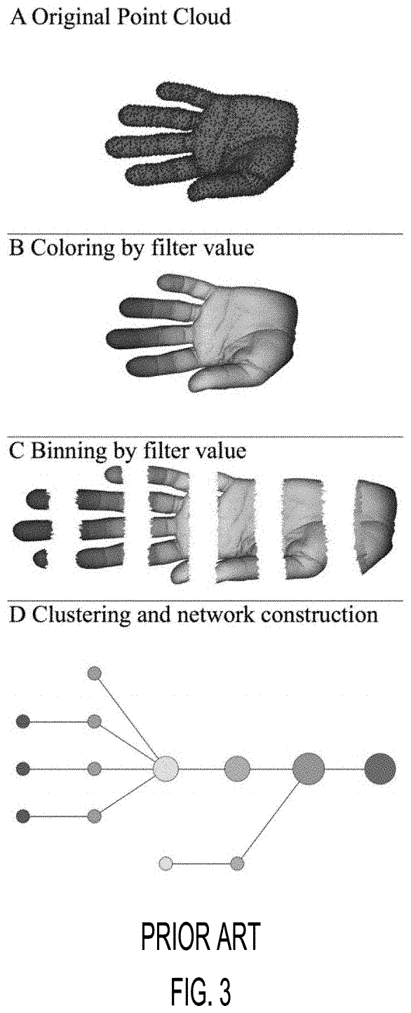

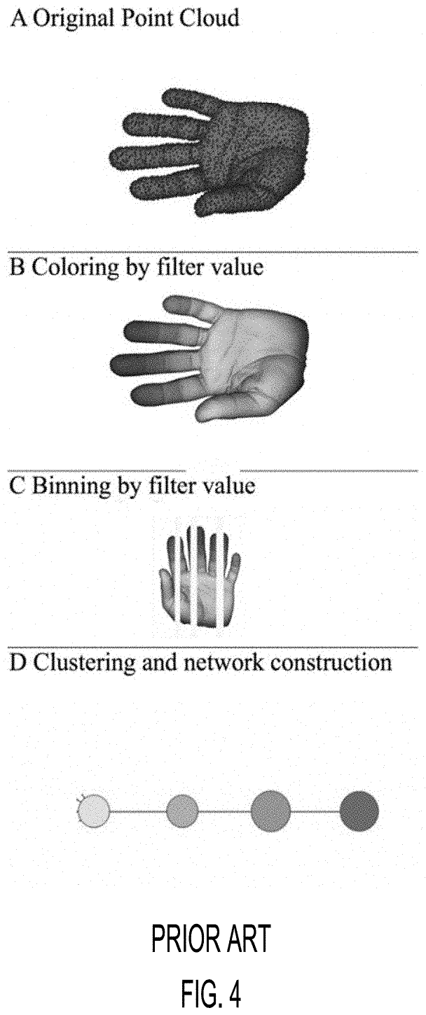

Referring now to FIGS. 3 and 4, depicted is a comparison of visual representations of the Ayasdi algorithm when using different lens functions. As shown in FIG. 3, the original point cloud at (A) is first filtered by a color value. Next, the data is segmented at (C), according to a lens function. The lens function used to bin, or segment, the data represented in FIG. 3 is a lens function selected to preserve the general structure of the hand after clustering. As shown in (D) of FIG. 3, the general shape or structure of the hand is preserved in the final represented graph.

Referring specifically now to FIG. 4, depicted is an example output of the Ayasdi algorithm when used with a lens function that does not meaningfully preserve the structure, or desired information, of the input point cloud. As shown in FIG. 4, the same original point cloud and filtering techniques as those used in FIG. 3 are repeated. However, a different lens function, which partitions the point cloud along a different set of coordinates, is used. The resulting cluster of the data points hides the fact that the point cloud represented a hand, and instead results in a horizontal line of points that indicates very little about the initial dataset. The comparison of the clusters produced for both FIGS. 3 and 4 show the importance of using a proper lens function for the Ayasdi algorithm to produce results that are meaningful for future analysis. Thus, choosing the correct lens function is critical to a desired representation of data. The lens function must capture as much relevant information about the data as possible. In some implementations, the Ayasdi algorithm may perform sub-optimally when using more than three lens functions. It is therefore critical to impart as much information about the outcome as possible into the smallest possible number of lens functions.

To solve the foregoing issues, the systems and methods described herein can implement a supervised learning technique to train lens functions for use in unsupervised learning algorithms, such as Ayasdi. The supervised learning techniques implemented by the systems and methods described herein include generating a lens function that outputs a coordinate that imparts a larger amount of information about a desired outcome while discarding information that may obscure the desired outcome. These coordinates can be used as lens functions in unsupervised learning algorithms to improve clustering of relevant information.

The systems and methods described herein can train a supervised model, such as a multi-layer perceptron (MLP) network, to predict an outcome of interest, which can be a classification or a prediction based on the characteristics of the input data. The final layer of the neural network can predict the outcome. For example, the final layer of the neural network can output a probability value proportional to a likelihood that the input data corresponds to the outcome of interest. The parameters for the neural network can be tuned to include a number of intermediate layers, a number of neurons per intermediate layer, a learning rate, and other hyper-parameters. These aspects of the neural network can be tuned based on heuristic information, or can be predetermined based on the characteristics of the input data. The parameters of the neural network can be chosen to improve the accuracy of the output values generated by the neural network.

The systems and methods described herein can place a constraint on the number of neurons in a selected hidden layer of the neural network. The number of neurons in the selected hidden layer can be equal to the desired number of lens functions, and can have the fewest number of neurons in any hidden layer in the neural network, and thus be referred to as a bottleneck layer. The bottleneck layer can be any hidden layer within the neural network. Depending on the neural network application, the depth of the neural network may be a factor in selecting layer as the bottleneck layer. Because the number of lens functions usable by Ayasdi or other unsupervised learning algorithms can be small (e.g., two or three, etc.), this selected hidden layer can be called a “bottleneck layer.” All information from the input data must propagate through the bottleneck before it can propagate through the rest of the network. Because the bottleneck layer has so few neurons, very little information from the input data can be transferred to the rest of the network. To best predict the outcome, the weights, biases, and other changeable aspects of the neural network must be altered to pass the most information possible about the outcome through the bottleneck layer.

The weights, biases, or other features of the bottleneck layer can be extracted from the neural network after a training condition is met. One type of training condition can be the performance (e.g., accuracy, etc.) of the neural network on a test set of data. When training a neural network, the datasets used to train the weights and biases of the neurons can be divided into at least two groups: a training dataset, and a test dataset. Both of these datasets can be labeled. However, the weights and biases can be adjusted based only on the training dataset. After a batch, or predetermined group, of the training dataset has been used to adjust (e.g., train) the weights and biases of the neural network, the set of test data can be propagated through the network to evaluate the accuracy of the network. A condition that indicates that training is complete can be when the neural network correctly classifies a percentage of the test data set that is greater than a predetermined value (e.g., 95%, 98%, 99%, etc.). Once the training condition is met, the weights, and biases if present, of the bottleneck layer can be extracted from the neural network, and used to generate a lens function that takes data of the same dimensionality as that used to train the neural network and produces a coordinate value as an output. The coordinates generated by the lens functions in response to input data can then be used to identify a corresponding bin, or segment, to which the input data belongs for the purposes of an unsupervised learning algorithm.

One example test case of this process can be applied to patient medical data. For the purposes of this example, consider the desired outcome to be a prediction of whether a cardiac event would occur in a patient if the patient engages in a particular therapy, for example a PD-1 or PD-L1 inhibitor (generally referred to as checkpoint inhibitor therapy) used for cancer therapy. As heart disease is a function of both tumor biology and cardiac history, it is important to evaluate patients based on both of these data items to determine whether a cardiac event is likely when undergoing PD-1/PD-L1 treatment.

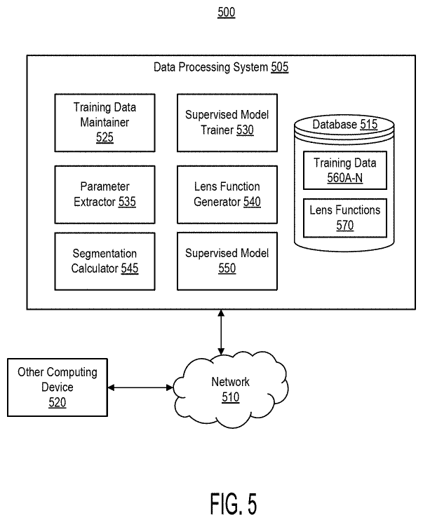

Referring now to FIG. 5, illustrated is a block diagram of an example system 500 for generating a lens function using supervised learning techniques, in accordance with one or more implementations. The system 500 can include at least one data processing system 505, at least one network 510, and at least one client device 520. The data processing system 505 can include at least one database 515, at least one training data maintainer 525, at least one supervised model trainer 530, at least one parameter extractor 535, at least one lens function generator 540, at least one segmentation calculator 545 and at least one supervised model 550. The database can include training data 560A-N (sometimes referred to generally as “training data 560”) and one or more lens functions 570.

Each of the components (e.g., the data processing system 505, the network 510, the client device 520, the database 515, the training data maintainer 525, the supervised model trainer 530, the parameter extractor 535, the lens function generator 540, the segmentation calculator 545 and the supervised model 550, etc.) of the system 500 can be implemented using the hardware components or a combination of software with the hardware components of a computing system (e.g., server system 900, client computing system 914, etc.) detailed herein in conjunction with FIG. 900. Each of the components of the system 500 can perform the functionalities detailed herein.

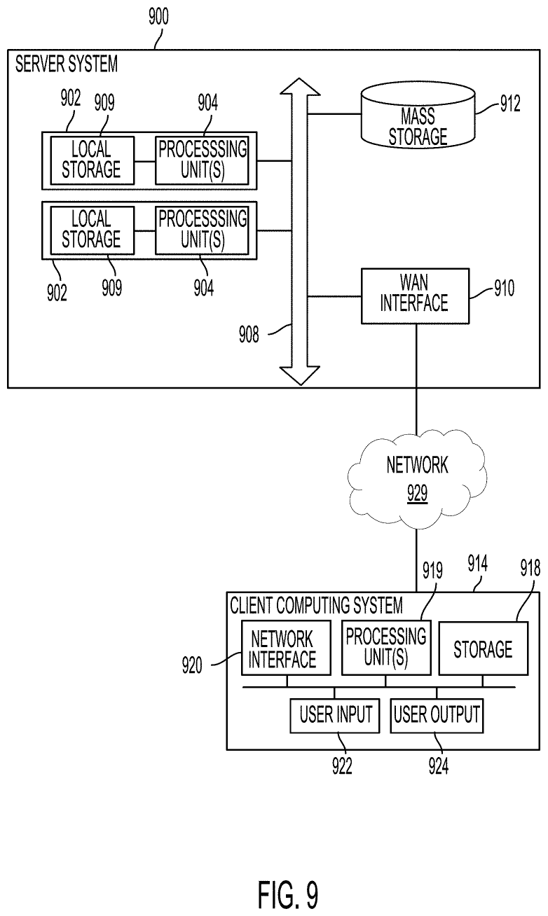

The data processing system 505 can include at least one processor and a memory, e.g., a processing circuit. The memory can store processor-executable instructions that, when executed by the processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 505 can include one or more computing devices or servers that can perform various functions as described herein. The data processing system 505 can include any or all of the components and perform any or all of the functions of the server system 900 or the client computing system 914 described herein below in conjunction with FIG. 9.

The network 510 can include computer networks such as the Internet, local, wide, metro or other area networks, intranets, satellite networks, other computer networks such as voice or data mobile phone communication networks, and combinations thereof. The data processing system 505 of the system 500 can communicate via the network 510, for instance with at least one client device 520. The network 510 may be any form of computer network that can relay information between the client device 520, the data processing system 505, and one or more content sources, such as web servers or cloud-storage servers, amongst others. In some implementations, the network 510 may include the Internet and/or other types of data networks, such as a local area network (LAN), a wide area network (WAN), a cellular network, a satellite network, or other types of data networks. The network 510 may also include any number of computing devices (e.g., computers, servers, routers, network switches, etc.) that are configured to receive and/or transmit data within the network 510. The network 510 may further include any number of hardwired and/or wireless connections. Any or all of the computing devices described herein (e.g., the data processing system 505, the client device 520, etc.) may communicate wirelessly (e.g., via WiFi, cellular, radio, etc.) with a transceiver that is hardwired (e.g., via a fiber optic cable, a CAT5 cable, etc.) to client devices in the network 510. Any or all of the computing devices described herein (e.g., the data processing system 505, the other computing system 520, etc.) may also communicate wirelessly with the computing devices of the network 510 via a proxy device (e.g., a router, network switch, or gateway). In some implementations, the network 510 can be, or can form a part of, the network 929 described herein below in conjunction with FIG. 9.

The database 515 can be a database configured to store and/or maintain any of the information described herein. The database 515 can maintain one or more data structures, which may contain, index, or otherwise store each of the values, groups, sets, variables, vectors, data structures, or thresholds described herein. The database 515 can be accessed using one or more memory addresses, index values, or identifiers of any item, structure, or region maintained in the database 515. The database 515 can be accessed by the components of the data processing system 505, or any client device described herein, via the network 510. In some implementations, the database 515 can be internal to the data processing system 505. In some implementations, the database 515 can exist external to the data processing system 505, and may be accessed via the network 510. The database 515 can be distributed across many different computer systems or storage elements, and may be accessed via the network 510 or a suitable computer bus interface. The data processing system 505 can store, in one or more regions of the memory of the data processing system 505, or in the database 515, the results of any or all computations, determinations, selections, identifications, generations, constructions, or calculations in one or more data structures indexed or identified with appropriate values. Any or all values stored in the database 515 may be accessed by any computing device described herein, such as the data processing system 505, to perform any of the functionalities or functions described herein.

The training data 560 maintained in the database 515 can be stored in one or more data structures, such as a list or indexed lookup table. The training data 560 can be stored, updated, modified, or otherwise accessed by any of the components of the data processing system 505. Generally, the training data 560 can be any kind of information that can be used to predict a desired output or characteristic. For example, training data 560 used to analyze whether a patient is at risk for a cardiac event when undergoing a particular treatment can include various medically relevant characteristics of a patient. Said another way, each item of training data 560 can correspond to a single respective patient, and include information that describes aspects of that patient. Furthering this example, an item of training data 560 can include the weight of patient, whether the patient has a history of hypertension, the average resting heartrate of a patient, a lymphocyte percentage of a patient, whether the patient has suffered from heart failure in the past, a T-cell count of the patient, magnesium levels or other electrolyte levels of a patient, or a body-mass-index (BMI) of a patient, among others.

Each item of the training data 560 can be numerically encoded such that it can be propagated through a supervised model, such as a MLP network. In some implementations, the training data 560 can be numerically encoded by the computing device that provides the training data 560 (e.g., the client device 520, etc.). In some implementations, the data processing system 505 can receive raw or unprocessed data and subsequently encode the information such that it can be propagated through a neural network. The encoding process can include, for example, generating a vector of input values (e.g., floating-point values, integers, etc.), where each position in the vector can represents a respective portion of the item of training data 560. In the example above, one portion can be the average resting heart rate of a patient, and another portion can be the weight of that patient. Because both of those values correspond to the same patient, they are inserted into the same vector, or item of training data 560. The number of positions or the dimensions of the data structure representing an item of training data 560 can be referred to as the dimensionality of the training data 560. Although vector is used as an example data structure to contain or represent an item of encoded training data 560, it should be understood that encoded training data 560 can be represented by any type of data structure (e.g., matrix, tensor, etc.).

For values of an item of training data 560 that can be considered binary (e.g., whether the patient has experienced heart failure, etc.), the position in the vector can be equal to a ‘0’ or a ‘1’, or any other value representing a “yes/no” binary relationship. For values that indicate a range, such as average resting heart rate, the value can be encoded as a floating point value bound by a predetermined range (e.g., between ‘0.0’ and ‘1.0’, etc.). For example, the resting heartrate of a patient can be divided by a maximum acceptable value for resting heartrate to arrive at a normalized heartrate value. In some implementations, each item of training data 560 can be normalized so that each position in the item of training data 560 is within a predetermined range.

In a supervised learning model, each item of training data 560 can be used in conjunction with a label that describes a ‘ground-truth’ about a characteristic of interest that can be predicted based on the training data 560. In the example above, the ground truth label can indicate whether the patient had a cardiac event when undergoing the particular treatment. When training the supervised model, the output of the model can be compared with the label of the item of training data 560. The difference between the output of the model and the label can be used to update the weights and biases of the neurons in the model, causing the model to produce a more accurate output. Thus, the dimensionality of the label informs the dimensionality of the output layer of the neural network. For example, if the output label is a binary classification (e.g., ‘0’ if not at risk for a cardiac event, ‘1’ if at risk for a cardiac event, etc.), the dimensionality of the output layer can be a single output value. Each item of training data 560 can be stored in association with a respective label. Although the training data 560 described herein has been described in the context of medical information, it should be understood that this an example, and should not be construed as limiting the training data 560 to being the medical information described herein above. The same applies for the ground truth labels.

The lens functions 570 maintained in the database 515 can be stored in one or more data structures, such as a list or indexed lookup table. The lens functions 570 can be stored, updated, modified, or otherwise accessed by any of the components of the data processing system 505. The lens functions 570 can be generated by the components of the data processing system 505, as described in detail herein below. Each lens function 570 can be generated based on the weights and biases of the neurons of a neural network that is trained using a supervised learning technique. In particular, the lens function 570 can include the weights and biases for a bottleneck layer in supervised model 550, and all of the layers of the neural network that precede the bottleneck layer. If the neural network includes the bottleneck layer immediately following the input layer, the lens functions 570 can include all the weights and biases of the neurons of the bottleneck layer. As the weights and biases can be extracted directly from the supervised model 550, a lens function 570 can accept input data in the same format as the training data 560 used to train the supervised model 550. The weights and biases for a single lens function 570 can be extracted from a respective neuron in the bottleneck layer of the supervised model 550.

A lens function 570 can therefore have a number of weight values that are equal to (or greater than in the case where the bottleneck layer does not immediately follow the input layer) the number of output values of the layer in the neural network that precedes the bottleneck layer. When the layer preceding the bottleneck layer is the input layer, the number of weight values in the lens function 570 can be equal to the dimensionality of the input layer times the number of neurons in the bottleneck layer. In cases where different types of supervised models are used, a different formula could apply. For example, in a convolutional neural network layer, the neurons can receive input from a subset of the previous layer. In such implementations, the number of weight values in a lens function can be adapted according to the total number of weights across the neurons in the convolution layer. To process input data (e.g., a data structure having the same dimensionality as an item of training data 560, etc.) using the lens, each weight value in the lens can be multiplied by a the value in the corresponding position in the input data structure (e.g., matching the structure of the neural network, etc.). Each of the resulting products can be summed, and a bias value (e.g., if used or specified as part of the neural network parameters, etc.) can be added to the sum. Finally, the resulting sum can be used as an input to an activation function (e.g., step function, sign function, sigmoid function, hyperbolic tangent function, etc.), which can produce a final output scalar value within a predetermined range (e.g., based on the activation function used, etc.).

The client device 520 can include at least one processor and a memory, e.g., a processing circuit. In some implementations, the client device 520 forms a part of the data processing system 505. The memory can store processor-executable instructions that, when executed by the processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The client device 520 can include one or more computing devices or servers that can perform various functions as described herein. The client device 520 can include any or all of the components and perform any or all of the functions of the server system 900 or the client computing system 914 described herein in conjunction with FIG. 9.

The client device 520 can provide training data (e.g., the training data 560, etc.) to the data processing system 505 to generate one or more lens functions using a supervised learning technique. In some implementations, the training data can be provided to the data processing system 505 as part of a request for one or more lens functions (e.g., the lens functions 570). The request for a lens function can include the training data 560 used to train the requested lens function 570, and can include parameters for the supervised learning technique that is used to generate the requested lens function 570. For example, the parameters can include the type of supervised learning technique, such as a type of neural network (e.g., MLP, etc.), and the parameters of that technique. Some examples of MLP network parameters can include a number of intermediate layers in the MLP network, a number of neurons per intermediate layer in the MLP network, a learning rate of the MLP network, and other adjustable hyper-parameters. After one or more lens functions 570 have been generated in response to the request, the client device 520 can receive a response to the request from the data processing system 505 that includes the generated lens functions 570.

In some implementations, the client device 520 can transmit a request for an unsupervised learning technique to be performed using the generated lens functions 570 on a specified dataset. The specified dataset can be included in the request for the unsupervised analysis. In response to the request, the client device 520 can receive a directed graph and other analysis information in a response message from the data processing system. The client device 520 can then visually display the directed graph (e.g., in a web-browser or another type of application, etc.).

Referring now to the operations of the data processing system 505, the training data maintainer 525 can maintain labeled training data 570 having a first dimensionality in the database 115 or in the memory of the data processing system. Maintaining the training data 560 in the database 115 can include receiving the training data 560 (e.g., including labels as described herein above, etc.) from the client device 520, for example as part of a request to generate one or more lens functions 570. The request to generate the lens functions 570 can include model training parameters, which can be provided to the supervised model trainer 530 for use in supervised learning. In some implementations, the training data maintainer 560 can receive the training data from another source, for example a bus or interconnect (e.g., the bus or interconnect 908 described herein below in conjunction with FIG. 9, etc.) of the data processing system 505. In some implementations, the training data maintainer 525 can encode information received from the client device into encoded data, as described herein above. Each item of training data 560 stored by the data record maintainer 130 can be associated with a location, address, or pointer to a location in the database 115 (or the memory of the data processing system 505), at which the respective item of training data resides. The training data maintainer 525 (e.g., or any other component of the data processing system 105) can access the training data 560, including the labels and data structures of each item of training data 560, using the corresponding location.

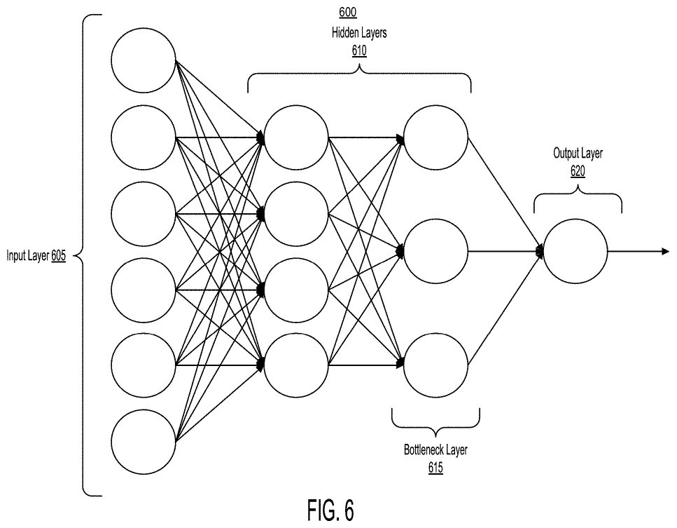

The supervised model trainer 530 can train a model, such as the supervised model 550, using a supervised learning technique and the labeled training data 560. The supervised model 550 can be, for example, a classification model or a regression model, among others. The supervised model 550 can be a neural network such as a MLP network. The parameters of the supervised model 550 can be received in a request for the generation of one or more lens functions 570, received for example from the client device 520. Prior to training, the supervised model trainer 530 can first generate the supervised model 550 based on the parameters included in the request. In some implementations, the parameters for the neural network are predetermined, or determined based on the dimensionality of the training data 560 and the dimensionality of the labels in the training data 560. For example, the size of the input layer of the supervised model 550 can be selected to match the dimensionality of the training data 560, and the size of the output layer selected to match the dimensionality of the labels in the training data 560. Generating the supervised learning model 550 can include defining or generating the structure of the supervised model 550. Structural aspects of the supervised model 550 can include the dimensionality of the input layer, the number of layers in the model, the number of neurons in each layer, the dimensionality of the output layer, the activation function in each neuron, and the connections between the neurons in each layer (which can be associated with corresponding weight values or bias values), among others. To generate the supervised model 550, the supervised model trainer 530 can allocate one or more data structures in the memory of the data processing system 505 for the neurons in the supervised model 505, and any associated weight values, bias values, or activation function parameters. An example depiction of a supervised model 550 is shown in FIG. 6 and described herein below.

Referring briefly now to FIG. 6, depicted is an example structure of a MLP network 600, which can be the similar to or the same as the supervised model 550. The MLP network 600 depicted in FIG. 6 is a feed-forward neural network, with an input layer 605 comprising six neurons, and an output layer comprising one neuron. However, it should be understood that the number of neurons in the input layer can be generated to match the dimensionality of the training data 560, and the number of neurons in the output layer can be generated to match the dimensionality of the output layer 620. The input layer can take as input an item of the training data 560 and propagate that information through the other layers in the neural network. Other layers in the MLP network 600 can include the hidden layers 610, which can take information from previous layers, perform computations on that information, and propagate that information to the neurons in the next layer. The connections in the neural network indicate the flow of information from one neuron to another neuron (e.g., from left to right). Because neurons in MLP networks can generally have a single value as output, neurons depicted with one many outputs (e.g., originating at the neuron and pointing outward) can provide that output value to each of the neurons accepting that value as input. Likewise, as the MLP network 600 depicted is a fully connected network, each neuron in any given layer can accept the output values of all neurons in the preceding layer.

The MLP network 600 can include a bottleneck layer 615. Although the bottleneck layer 615 is depicted as including three neurons, it should be understood that the number of neurons in the bottleneck layer 615 can be equal to the desired number of lens functions. Likewise, the number of neurons in any hidden layer 610 is not necessarily fewer than the number of neurons in the preceding layer, and can be generated to include any number of neurons. Further, it should be appreciated that any number of hidden layers can be used. The position of the bottleneck layer 615 in the neural network can be specified as part the model parameters. The number of neurons in the hidden layer and the number of hidden layers in the network can also be specified as part of the model parameters. The output layer 620 may not connect to any neuron, and instead can provide its output value as a trained classification or prediction about the item training data 560 used as input.

To propagate information through the MLP network 600, each neuron in the input layer 605 can be set to a value equal to a corresponding portion (e.g., coordinate of a vector or other data structure, etc.) of an item of training data 560, or other data having similar dimensionality and does not necessarily include a label. Each neuron in the following layer (depicted here as the bottleneck layer 615) can perform the following computation on the input data to produce an output value:

$$y = f ( {\sum }_{i = 0}^{N} {w}_{i} {x}_{i} + b ) ,$$

where y is the output value of the neuron, wᵢ is weight value for the corresponding value in the previous layer xᵢ, b is the bias value of the neuron, and Nis the number of neurons in the preceding layer. The function ƒ can be an activation function, which can include a sigmoid function, a hyperbolic tangent function, a sign function, or a step function, among others.

The formula provided above can be performed (e.g., by the supervised model trainer 530, etc.) to produce an output value for each neuron in the neural network. Neurons in subsequent layers can take as input the output values of previous neurons in the neural network, as depicted by the connections between neurons in the MLP network 600. Thus, the final output value is a function including all of the weights, biases, and activation functions of all neurons that precede the neuron in the network. To achieve a desired result (e.g., the output value indicates an accurate prediction of a characteristic of the input data, etc.), the weights and biases of the neurons in the MLP network 600 can be trained (e.g., by the supervised model trainer 530, etc.) using a supervised training algorithm, such as a backpropagation algorithm. The training process is described herein below.

Referring back now to FIG. 5, the supervised model trainer 530 can train the generated supervised model 550, such as the MLP network 600 described herein above, using a backpropagation algorithm. In brief overview, backpropagation is the process of determining the difference (or error) between the output value of the neural network (e.g., the output value(s) of the output layer) and an expected ground truth output. As described above, the expected ground truth output of any item of training data 560 can be stored in association with the item of training data 560 as a ground truth label. After the supervised model trainer 530 determines this difference, the supervised model trainer 530 can use a backpropagation algorithm to adjust the weights and biases of the neural network to result in an output that more closely resembles the ground truth label.

In further detail of the training algorithm, the supervised model trainer 530 can perform a backpropagation algorithm to adjust the weights and biases of the supervised model 550 to increase the overall accuracy of the model. To do so, the supervised model trainer 530 can first propagate an item of training data 560 through the supervised model 550, and compute an error in the output of the model, which can be based on the difference between the output of the model and the label of the training data 560. Next, the amount of error for the layer preceding the output layer can be computed based on the amount of error calculated for the output layer. This process can be repeated for each layer until the input layer is reached. The total amount of error for each layer, including the output layer, can be computed using a loss function (e.g., mean squared error, mean squared logarithmic error, mean absolute error, binary cross-entropy, hinge-loss, squared hinge loss, etc.). Each of the weights and biases of the neurons in each layer can be adjusted based on the computed error for that layer by using an optimization function, such as gradient descent, stochastic gradient descent, or mini-batch gradient descent, among others. The optimization function can output a change in the weights values and bias values to minimize the loss function. The amount by which the weights and biases are changed can be multiplied by a learning rate factor. The learning rate factor, as well as the type of loss function or optimization function used, can be specified in the parameters of the supervised model.

In some implementations, the supervised model trainer 530 can train the supervised model 550 in batches. In a batch learning arrangement, the items of training data 560 can be divided into one or more batches, and the amount of error for the output can be aggregated and computed for the entire batch. Then, the weights and biases of the network can be updated based on the learning rate and based on the amount of error computed for the batch. This process can be repeated over many batches, until the entire training data 560 set has been used to train the model. In some implementations, the entire training data 560 can be used to train the supervised model multiple times, where each full pass through the entire training data 560 set is referred to as an epoch. The number of epochs, and the size of the batches that make up an epoch, can be specified in the parameters of the supervised model.

To evaluate the progress of training, the training data 560 can have a predetermined number of items of training data 560 that are designated as a test set. After updating the weights and biases of the supervised model 550 a predetermined number of times, the items training data 560 making up the test set can be propagated through the network to determine the overall accuracy of the model. The accuracy of the supervised model can be determined by comparing the output of the supervised model 550 for each item of the test dataset to the label associated with the respective item of the dataset. The accuracy of the model can be the percentage of the items in the test dataset for which the supervised model 550 can accurately compute (or “predict”) the associated ground-truth label. In some implementations, after the supervised model is determined to have an accuracy that is greater than a predetermined threshold, the supervised model 550 can be used to generate the lens functions 570. In some implementations, the supervised model 550 can be used to generate the lens functions 570 after a different condition has been reached (e.g., a predetermined number of the items of training data 560 have been used to train the model, etc.). After training, the supervised model trainer 530 can store the parameters of the model (e.g., weights, biases, connections, dimensions, activation functions, learning rate, other parameters, etc.) in one or more data structures in the memory of the data processing system 505.

After the supervised model 550 is trained, the parameter extractor 535 can extract weight values, bias values, activations functions, or other parameters useable to generate the lens function from the one or more bottleneck neurons of the supervised model. As described herein above, the bottleneck neurons are a layer of the supervised model 550 having a number of neurons specified as equal to the desired number of lens functions. This number is chosen because the function that describes the output of a bottleneck neuron (e.g., all input values and outputs from previous layers propagated through the bottleneck neuron, etc.) can be used as a lens function. To generate the lens functions, the parameter extractor 535 can extract (e.g., copy to another region of memory, such as a region of working memory, in the data processing system 505, etc.) the weight values, bias values, activation functions, structure, or other parameters of the bottleneck neuron from the one or more data structures storing the supervised model 550.

Next, the parameter extractor 535 can extract the weights, biases, activation functions, and structure for each of the neurons that precede the bottleneck neuron. If the preceding layer is the input layer, the process can complete and the parameters of the bottleneck neuron can be provided to the lens function generator 540 for further processing. Otherwise, the parameter extractor 535 can extract the weight values, bias values, activation functions, structure, or any other parameters from the neurons that provide an input to the respective bottleneck neuron. If the layer that precedes that layer is also not the input layer, the parameter extractor can extract the parameters for each neuron that contributes to an input of the preceding layer, and so on until the input layer is reached. Put more simply, the parameter extractor 535 can extract the parameters of any neuron that directly or indirectly contributes to the output value of the bottleneck neuron. The parameter extractor 535 can repeat this process for each bottleneck neuron in the bottleneck layer of the supervised model 550, and store each of the sets of parameters that contribute to the output of each bottleneck neuron in a respective data structure, which can be indexed by an identifier of the respective bottleneck neuron.

The lens function generator 540 can access the data structures including the parameters of the bottleneck neurons to generate one or more lens functions 570. Each of the lens functions 570 can be generated to generally maintain the structure of the supervised model that contributes to the bottleneck neuron to which the lens function 570 corresponds. For example, in a simple case where a bottleneck neuron immediately follows the input layer, the following equation can represent the lens function.

$$L ( x ) = {f}_{z} ( {\sum }_{i = 0}^{N} {w}_{zi} {x}_{i} + {b}_{z} ) ,$$

where L(x) can represent the lens function with input data item x,η_{z} can represent the activation function for the corresponding bottleneck neuron z, w_{zi} represents the weight values for the i-th portion of training data for the corresponding bottleneck neuron z, xᵢ represents the i-th position (e.g., data structure index such as a vector coordinate, etc.) of the input data x, and b_{z} represents the bias value of the corresponding bottleneck neuron z. In circumstances where the bottleneck layer does not immediately follow the input layer, the equation for the lens function can be generated to mimic the structure and operations of the neural network up to and including the respective bottleneck neuron. For example, the function could resemble a recursive version of the function included above, where the input xᵢ can be equal to the function of the i-th neuron in the preceding layer, and so on. Thus, generating the lens function can include generating one or more data structures that preserve the structure of the neural network up to and including the corresponding bottleneck neuron z. The lens function generator 540 can generate a lens function for each bottleneck neuron in the trained supervised model 550. The data structures including the lens functions can be packaged or structured such that they are useable by an unsupervised learning algorithm, such as Ayasdi. The lens functions can be stored, for example, in the database 515 as the lens functions 570, or can be stored in one or more regions of memory in the data processing system 505. In some implementations, the lens functions 570 can be packaged into one or more response messages that are transmitted to the client device 520 in response to a request for one or more lens functions 570.

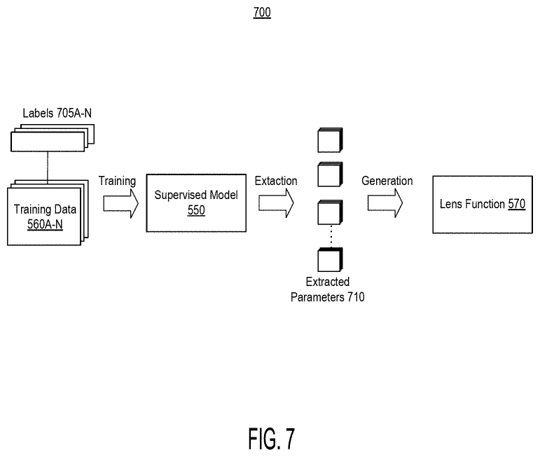

Referring briefly now to FIG. 7, depicted is an example data-flow diagram 700 of the generation of lens functions using a supervised learning technique. As shown in the diagram 700, the training data 560A-N is stored used in conjunction with corresponding ground-truth labels in a training process, such as the training process performed by the supervised model trainer 530. The training process generates a trained supervised model 550. Next, the weights, biases, activation functions, and other relevant parameters are extracted from each of the bottleneck neurons in the supervised model 550 in an extraction process, such as the extraction process performed by the parameter extractor 535. The extracted parameters can be used in a lens generation process, such as the lens generation process performed by the lens function generator 540, to generate corresponding lens functions 570 for each of the bottleneck neurons in the trained supervised model 550. The generated lens functions 570 can then be used in an unsupervised learning algorithm, such as Ayasdi, as described herein below.

Referring back now to FIG. 5, the segmentation calculator 545 can calculate segmentation information using the lens functions 570 for input data having similar dimensionality as the training data 560. In some implementations, the segmentation calculator 545 can segment the input data in response to a request for an unsupervised learning technique to be applied to the input data. In such implementations, the input data can be specified in the request for the unsupervised learning technique. In some implementations, the input data can be retrieved from the memory of the data processing system 505, or from one or more data structures in the database 515. The input data used in the segmentation process can have the same dimensionality as the training data 560 used to generate the supervised model 550. As each of the lens functions 570 correspond to a portion of the structure of the supervised model 550, each of the lens functions 570 can take an input value of the same format as the training data 560 (e.g., same dimensions, number of positions, and encoded information types at each position, etc.).

To segment the information using the one or more lens functions, the segmentation calculator 545 can apply each item of input data as an input to a lens function 570. If more than one lens function 570 is used in the segmentation process, the segmentation calculator can apply each item of input data as an input to each of the lens functions 570. The segmentation calculation can then perform all of the computations necessary to compute the output of the lens function. For example, the segmentation calculator 545 can compute output of the lens function by propagating the input information through each of the weights, biases, transforms, and activation functions present in the lens function, as described herein above. The output value of a lens function can be a scalar value that is within a predetermined range (e.g., between zero and one, etc.). A resolution value can be used to segment the predetermined range into one or more segments identified by a portion of the predetermined range. For example, if a resolution value of two is used, and the predetermined output range is between 0.0 and 1.0, the first segment can be identified by the range of [0.0, 0.5), and the second segment can be identified by the range of [0.5, 1.0]. If the output value for a particular input data item falls within a sub-range, the input data item can be assigned to the segment that corresponds to that range. A gain parameter can be used to determine the extent to which the ranges of any two segments overlap. The gain parameter can be a predetermined parameter stored in the memory of the data processing system 505. In some implementations, the gain parameter can be specified in the request for the unsupervised learning technique.

In some implementations, multiple lens functions 570 can be used to segment the input data across multiple dimensions. For example, if two lens functions 570 are generated from two corresponding bottleneck neurons in the bottleneck layer of the supervised model 550, the input data can be segmented into two dimensions, where each dimension of the two-dimensional space corresponds to a lens function 570. Each lens function can be associated with a respective resolution value and a respective gain value. Thus, N lens functions 570 can map the input dataset into an N-dimensional open covered space. The mapping can be represented by a vector of coordinates, and can be stored in one or more data structures in association with the respective item of input data. The segmentation process can be repeated for each item in the input dataset until all items are mapped into the segmented space. The segmented output coordinates, and their respective mappings, can be provided to the client device 520 in response to the request for the unsupervised learning technique, or can be used in further unsupervised learning analysis, such as a clustering algorithm. A clustering algorithm can output a directed graph indicating relationships between groups of the segmented input data. The directed graph can be stored in one or more data structures in association with the input data items used in the unsupervised learning process.

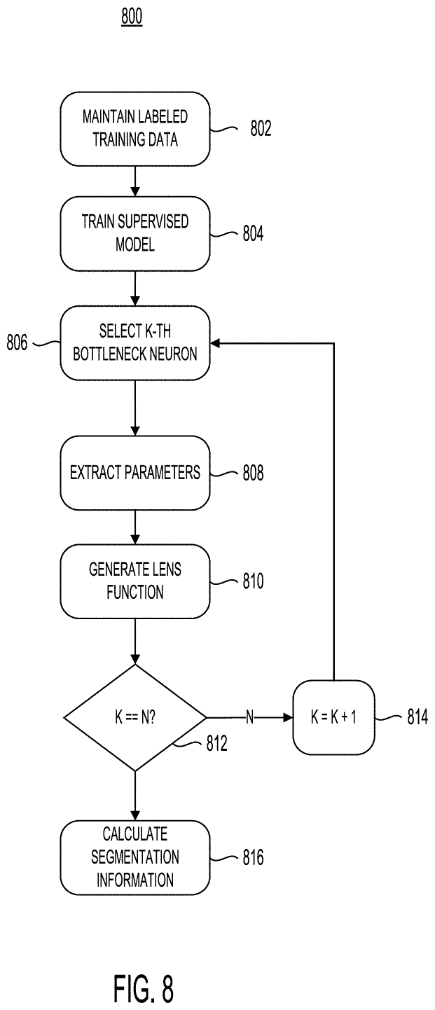

Referring now to FIG. 8, depicted is an illustrative flow diagram of a method 800 for generating a lens function using supervised learning techniques. The method 800 can be executed, performed, or otherwise carried out by the data processing system 505, the client device 520, the server system 900 or the client computing system 914 described herein in conjunction with FIG. 9, or any client devices described herein. In brief overview, the data processing system (e.g., the data processing system 505, the client device 520, the server system 900, the client computing system 914, etc.) can maintain labeled training data (STEP 802), train a supervised model (STEP 804), select the k-th bottleneck neuron in the trained supervised model (STEP 806), extract parameters from the selected bottleneck neuron (808), generate a lens function (810), determine whether the counter register k is equal to the number of bottleneck neurons n (STEP 812), increment the counter register k (STEP 814), and calculate segmentation information (STEP 816).

In further detail of the method 800, the data processing system can maintain labeled training data (e.g., the training data 560, etc.) (STEP 802). The training data can be stored in one or more data structures in a database (e.g., the database 115). Maintaining the training data in the database can include receiving the training data (e.g., including labels as described herein above, etc.) from an external computing device (e.g., the client device 520), for example as part of a request to generate one or more lens functions (e.g., the lens functions 570). The request to generate the lens functions can include model training parameters, which can used in a supervised learning process to train a supervised model (e.g., the supervised model 550, etc.). In some implementations, the data processing system can receive the training data from another source, for example a bus or interconnect of the data processing system. In some implementations, the data processing system can encode information received from the client device into encoded data, as described herein above. Each item of training data stored by the data processing system can be associated with a location, address, or pointer to a location in computer memory or in the database, at which the respective item of training data resides.

The data processing system can train a supervised model (STEP 804). The supervised model can be trained using a supervised learning technique. The supervised model can be, for example, a neural network such as a MLP network. The parameters of the supervised model can be received in a request for the generation of one or more lens functions, received for example from an external computing device. Prior to training, the data processing system can first generate the supervised model based on the parameters included in the request. In some implementations, the parameters for the neural network are predetermined, or determined based on the dimensionality of the training data and the dimensionality of the labels in the training data. For example, the size of the input layer of the supervised model can be selected to match the dimensionality of the training data, and the size of the output layer selected to match the dimensionality of the labels in the training data. Generating the supervised learning model can include defining or generating the structure of the supervised model. Structural aspects of the supervised model can include the dimensionality of the input layer, the number of layers in the model, the number of neurons in each layer, the dimensionality of the output layer, the activation function in each neuron, and the connections between the neurons in each layer (which can be associated with corresponding weight values or bias values), among others. To generate the supervised model, the data processing system can allocate one or more data structures in the memory of the data processing system for the neurons in the supervised model 505, and any associated weight values, bias values, or activation function parameters. An example depiction of a supervised model is shown in FIG. 6 and described herein above.

The data processing system can train the generated supervised model using a backpropagation algorithm. In brief overview, backpropagation is the process of determining the difference (or error) between the output value of the neural network (e.g., the output value(s) of the output layer) and an expected ground truth output. As described above, the expected ground truth output of any item of training data can be stored in association with the item of training data as a ground truth label. After the data processing system determines this difference, the data processing system can use a backpropagation algorithm to adjust the weights and biases of the neural network to result in an output that more closely resembles the ground truth label.

In further detail of the training algorithm, the data processing system can perform a backpropagation algorithm to adjust the weights and biases of the supervised model to increase the overall accuracy of the model. To do so, the data processing system can first propagate an item of training data through the supervised model, and compute an error in the output of the model, which can be based on the difference between the output of the model and the label of the training data. Next, the amount of error for the layer preceding the output layer can be computed based on the amount of error calculated for the output layer. This process can be repeated for each layer until the input layer is reached. The total amount of error for each layer, including the output layer, can be computed using a loss function (e.g., mean squared error, mean squared logarithmic error, mean absolute error, binary cross-entropy, hinge-loss, squared hinge loss, etc.). Each of the weights and biases of the neurons in each layer can be adjusted based on the computed error for that layer by using an optimization function, such as gradient descent, stochastic gradient descent, or mini-batch gradient descent, among others. The optimization function can output a change in the weights values and bias values to minimize the loss function. The amount by which the weights and biases are changed can be multiplied by a learning rate factor. The learning rate factor, as well as the type of loss function or optimization function used, can be specified in the parameters of the supervised model.

In some implementations, the data processing system can train the supervised model in batches. In a batch learning arrangement, the items of training data can be divided into one or more batches, and the amount of error for the output can be aggregated and computed for the entire batch. Then, the weights and biases of the network can be updated based on the learning rate and based on the amount of error computed for the batch. This process can be repeated over many batches, until the entire training dataset has been used to train the model. In some implementations, the entire training data can be used to train the supervised model multiple times, where each full pass through the entire training dataset is referred to as an epoch. The number of epochs, and the size of the batches that make up an epoch, can be specified in the parameters of the supervised model.

To evaluate the progress of training, the training dataset can have a predetermined number of items of training data that are designated as a test dataset. After updating the weights and biases of the supervised model a predetermined number of times, the items training data making up the test dataset can be propagated through the network to determine the overall accuracy of the model. The accuracy of the supervised model can be determined by comparing the output of the supervised model for each item of the test dataset to the label associated with the respective item of the dataset. The accuracy of the model can be the percentage of the items in the test dataset for which the supervised model can accurately compute (or “predict”) the associated ground-truth label. In some implementations, after the supervised model is determined to have an accuracy that is greater than a predetermined threshold, the supervised model can be used to generate the lens functions. In some implementations, the supervised model can be used to generate the lens functions after a different training condition has been reached (e.g., a predetermined number of the items of training data have been used to train the model, etc.). The data processing system can store the parameters of the model (e.g., weights, biases, connections, dimensions, activation functions, learning rate, other parameters, etc.) in one or more data structures in the memory of the data processing system.

The data processing system can select the k-th bottleneck neuron in the trained supervised model (STEP 806). To generate a lens function for each of the bottleneck neurons in the supervised model, the data processing system can iteratively loop through each of the bottleneck neurons in the supervised model based on a counter register k. Each of the bottleneck neurons in the supervised model can be stored and indexed in a data structure by an index value (e.g., index 0, index 1, index 2, etc.). To generate a lens function for each bottleneck neuron, the data processing system can select the register of the bottleneck neuron that is stored in association with an index value equal to the counter register k. If it is the first iteration of the loop, the counter register k may be initialized to an initialization value (e.g. k=0) before selecting the k-th bottleneck neuron. Accessing the bottleneck neurons in the supervised model can include copying the data associated with the selected bottleneck neuron to a different region of computer memory, for example a working region of memory in the data processing system.

The data processing system can extract parameters from the selected bottleneck neuron (808). The data processing system can extract weight values, bias values, activations functions, or other parameters useable to generate the lens function from the selected bottleneck neuron of the supervised model. As described herein above, the bottleneck neurons are a layer of the supervised model having a number of neurons specified as equal to the desired number of lens functions. This number is chosen because the function that describes the output of a bottleneck neuron (e.g., all input values and outputs from previous layers propagated through the bottleneck neuron, etc.) can be used as a lens function. To generate the lens functions, the data processing system can extract the weight values, bias values, activation functions, structure, or other parameters of the bottleneck neuron from the one or more data structures storing the supervised model.

Next, the data processing system can extract the weights, biases, activation functions, and structure for each of the neurons that precede the bottleneck neuron. If the preceding layer is the input layer, the process can complete and the parameters of the bottleneck neuron can be used in STEP 810. Otherwise, the data processing system can extract the weight values, bias values, activation functions, structure, or any other parameters from the neurons that provide an input to the selected bottleneck neuron. If the layer that precedes that layer is also not the input layer, the data processing system can extract the parameters for each neuron that contributes to an input of the preceding layer, and so on until the input layer is reached. Put more simply, the data processing system can extract the parameters of any neuron that directly or indirectly contributes to the output value of the selected bottleneck neuron. The data processing system can store the sets of parameters that contribute to the output of selected bottleneck neuron in a respective data structure in the memory of the data processing system.

The data processing system can generate a lens function (810). The data processing system can access the data structures including the parameters of the selected bottleneck neuron to generate a corresponding lens function. Each of the lens functions 507 can be generated to generally maintain the structure of the supervised model that contributes to the bottleneck neuron to which the lens function corresponds. In circumstances where the bottleneck layer is not the layer immediately following the input layer, the equation for the lens function can be generated to mimic the structure of the neural network up to and including the selected bottleneck neuron. Thus, generating the lens function can include generating one or more data structures that preserve the structure of the neural network up to and including the selected bottleneck neuron. The data structures including the lens function can be packaged or structured such that it is useable by an unsupervised learning algorithm, such as Ayasdi. The lens function can be stored, for example, in a database or in one or more regions of memory in the data processing system. In some implementations, the lens function can be packaged into one or more response messages transmitted to an external computing device in response to a request for one or more lens functions.

The data processing system can determine whether the counter register k is equal to the number of bottleneck neurons n (STEP 812). To determine whether a lens function has been generated for each bottleneck neuron in the supervised model, the data processing system can compare the counter register used to select each bottleneck neuron in the supervised model to the total number of registers in the first data structure n. If the counter register k is not equal to (e.g., less than) the total number of bottleneck neurons in the supervised model n, the data processing system can execute (STEP 814). If the counter register k is equal to (e.g., equal to or greater than) the total number of bottleneck neurons in the supervised model n, the data processing system can execute (STEP 816).

The data processing system can increment the counter register k (STEP 814). To generate a lens function for each bottleneck neuron in the supervised model, the data processing system can add one to the counter register k to indicate the number of bottleneck neurons for which a lens function has been generated. In some implementations, the data processing system can set the counter register k to a memory address value (e.g., location in computer memory) of the next location in memory of the next bottleneck neuron in the supervised model. After incrementing the value of the counter register k, the data processing system can execute (STEP 806).

The data processing system can calculate segmentation information (STEP 816). The data processing system can calculate segmentation information using the lens functions for input data having similar dimensionality as the training data. In some implementations, the data processing system can segment the input data in response to a request for an unsupervised learning technique to be applied to the input data. In such implementations, the input data can be specified in the request for the unsupervised learning technique. In some implementations, the input data can be retrieved from the memory of the data processing system. The input data that is segmented can have the same dimensionality as the training data used to generate the supervised model. As each of the lens functions correspond to a portion of the structure of the supervised model, each of the lens functions can take an input value of the same format as the training data (e.g., same dimensions, number of positions, and encoded information types at each position, etc.).

To segment the information using the one or more lens functions, the data processing system can apply each item of input data as an input to a lens function. If more than one lens function is used in the segmentation process, the data processing system can apply each item of input data as an input to each of the lens functions. The segmentation calculation can then perform all of the computations necessary to compute the output of the lens function. For example, because the lens function corresponds to the structure and weights of the supervised model, the data processing system can compute output of the lens function by propagating the input information through each of the weights, biases, transforms, and activation functions present in the lens function, as described herein above. The output value of a lens function can be a scalar value that is within a predetermined range (e.g., between zero and one, etc.). A resolution value can be used to segment the predetermined range into one or more segments identified by a portion of the predetermined range. For example, if a resolution value of two is used, and the predetermined output range is between 0.0 and 1.0, the first segment can be identified by the range of [0.0, 0.5), and the second segment can be identified by the range of [0.5, 1.0]. If the output value for a particular input data item falls within a sub-range, the input data item can be assigned to the segment that corresponds to that range. A gain parameter can be used to determine the extent to which the ranges of any two segments overlap. The gain parameter can be a predetermined parameter stored in the memory of the data processing system. In some implementations, the gain parameter can be specified in the request for the unsupervised learning technique.

In some implementations, multiple lens functions can be used to segment the input data across multiple dimensions. For example, if two lens functions are generated from two corresponding bottleneck neurons in the bottleneck layer of the supervised model, the input data can be segmented into two dimensions, where each dimension of the two-dimensional space corresponds to a lens function. Each lens function can be associated with a respective resolution value and a respective gain value. Thus, N lens functions can map the input dataset into an N-dimensional open covered space. The mapping can be represented by a vector of coordinates, and can be stored in one or more data structures in association with the respective item of input data. The segmentation process can be repeated for each item in the input dataset until all items are mapped into the segmented space. The segmented output coordinates, and their respective mappings, can be provided to an external computing device in response to the request for the unsupervised learning technique, or can be used in further unsupervised learning analysis, such as a clustering algorithm. A clustering algorithm can output a directed graph indicating relationships between groups of the segmented input data. The directed graph can be stored in one or more data structures in association with the input data items used in the unsupervised learning process.

Having now described some illustrated implementations of the present techniques, it will be appreciated that various implementations are contemplated. At least one aspect of the present disclosure relates to a method for generating a lens function using supervised learning techniques. The method can include maintaining, in a database, labeled training data having a first dimensionality. The method can include training, using a supervised learning technique and the labeled training data, a model including a plurality of layers. The plurality of layers can include an input layer having the first dimensionality and a bottleneck layer having one or more bottleneck neurons. The method can include extracting, responsive to training the model, weight values from the one or more bottleneck neurons. The method can include generating one or more lens functions using the weight values extracted from the one or more bottleneck neurons. The method can include calculating segmentation information for unlabeled data having the first dimensionality using the one or more lens functions.

In some implementations, the method can include storing, in one or more data structures, a mapping between the unlabeled data and the segmentation information. In some implementations, the method can include generating a directed graph using the mapping between the unlabeled data and the segmentation information. In some implementations, generating the directed graph can include applying a clustering algorithm to segmentation information to indicate relationships between groups of the unlabeled data. In some implementations, training the model can include updating the plurality of layers based on a backpropagation algorithm.

In some implementations, training the model can include determining an accuracy of the model. In some implementations, training the model can include terminating training of the model responsive to the accuracy of the model satisfying a predetermined threshold. In some implementations, extracting the weight values from the one or more bottleneck neurons can include storing the weight values in one or more data structures in memory of the data processing system. In some implementations, the one or more lens can include one or more bias values. In some implementations, extracting the weight values from the one or more bottleneck neurons can include extracting one or more bias values from the bottleneck neurons.

In some implementations, extracting the weight values from the one or more bottleneck neurons can include extracting additional weight values from at least one layer following the bottleneck layer. In some implementations, generating the one or more lens functions is based on the additional weight values extracted from the at least one layer following the bottleneck layer.

At least one other aspect of the present disclosure is directed to another method. The method can include maintaining one or more lens functions generated based on weight values extracted from a model trained using a supervised learning technique. The method can include receiving unlabeled data for use in an unsupervised learning technique. The method can include calculating segmentation information for the unlabeled data.

In some implementations, the method can include storing, in one or more data structures, a mapping between the unlabeled data and the segmentation information. In some implementations, the method can include generating a directed graph using the mapping between the unlabeled data and the segmentation information. In some implementations, generating the directed graph further comprises applying a clustering algorithm to segmentation information to indicate relationships between groups of the unlabeled data.

At least one other aspect of the present directed to another method. The method can include maintaining labeled training data having a first dimensionality. The method can include maintaining, in a database, labeled training data having a first dimensionality. The method can include training, using a supervised learning technique and the labeled training data, a model including a plurality of layers. The plurality of layers can include an input layer having the first dimensionality and a bottleneck layer having one or more bottleneck neurons. The method can include extracting, responsive to training the model, weight values from the one or more bottleneck neurons. The method can include generating one or more lens functions using the weight values extracted from the one or more bottleneck neurons.

In some implementations, training the model can include updating the plurality of layers based on a backpropagation algorithm. In some implementations, training the model can include determining an accuracy of the model. In some implementations, training the model can include terminating training of the model responsive to the accuracy of the model satisfying a predetermined threshold. In some implementations, extracting the weight values from the one or more bottleneck neurons can include storing the weight values in one or more data structures in memory of the data processing system.

In some implementations, the one or more lens can include one or more bias values. In some implementations, extracting the weight values from the one or more bottleneck neurons can include extracting one or more bias values from the bottleneck neurons. In some implementations, extracting the weight values from the one or more bottleneck neurons can include extracting additional weight values from at least one layer following the bottleneck layer. In some implementations, generating the one or more lens functions is based on the additional weight values extracted from the at least one layer following the bottleneck layer. In some implementations, the method can include calculating segmentation information for unlabeled data using the one or more lens functions.

At least one other aspect of the present disclosure is directed to a system. The system can include a data processing system comprising one or more processors coupled to memory. The system can maintain labeled training data having a first dimensionality. The system can train, using a supervised learning technique and the labeled training data, a model comprising a plurality of layers. The plurality of layers can include an input layer having the first dimensionality and a bottleneck layer having one or more bottleneck neurons. The system can extract, responsive to training the model, weight values from the one or more bottleneck neurons. The system can generate one or more lens functions based on the weight values extracted from the one or more bottleneck neurons. The system can calculate segmentation information for unlabeled data using the one or more lens functions.

In some implementations, the system can store, in one or more data structures, a mapping between the unlabeled data and the segmentation information. In some implementations, the system can generate a directed graph using the mapping between the unlabeled data and the segmentation information. In some implementations, to generate the directed graph, the system can apply a clustering algorithm to segmentation information to indicate relationships between groups of the unlabeled data.

In some implementations, to train the model, the system can update the plurality of layers based on a backpropagation algorithm. In some implementations, train the model, the system can determine an accuracy of the model, and terminate training of the model responsive to the accuracy of the model satisfying a predetermined threshold. In some implementations, to extract the weight values from the one or more bottleneck neurons, the system can store the weight values in one or more data structures in memory of the data processing system. In some implementations, the one or more lens functions comprise one or more bias values. In some implementations, to extract the weight values from the one or more bottleneck neurons, the system can extract one or more bias values from the bottleneck neurons.

In some implementations, to extract the weight values from the one or more bottleneck neurons, the system can extract additional weight values from at least one layer following the bottleneck layer. In some implementations, the system can generate the one or more lens functions further based on the additional weight values extracted from the at least one layer following the bottleneck layer.

At least one other aspect of the present disclosure is directed to another system. The system can include one or more processors coupled to memory. The system can maintain one or more lens functions generated based on weight values extracted from a model trained using a supervised learning technique. The system can receive unlabeled data for use in an unsupervised learning technique. The system can calculate segmentation information for the unlabeled data.

In some implementations, the system can store, in one or more data structures, a mapping between the unlabeled data and the segmentation information. In some implementations, the system can generate a directed graph using the mapping between the unlabeled data and the segmentation information.

In some implementations, to generate the directed graph, the system can apply a clustering algorithm to segmentation information to indicate relationships between groups of the unlabeled data.

At least one of other aspect of the present disclosure is directed to another system. The system can include a data processing system comprising one or more processors coupled to memory. The system can train, using a supervised learning technique and the labeled training data, a model comprising a plurality of layers. The plurality of layers can include an input layer having the first dimensionality and a bottleneck layer having one or more bottleneck neurons. The system can extract, responsive to training the model, weight values from the one or more bottleneck neurons. The system can generate one or more lens functions based on the weight values extracted from the one or more bottleneck neurons.

In some implementations, to train the model, the system can update the plurality of layers based on a backpropagation algorithm. In some implementations, train the model, the system can determine an accuracy of the model, and terminate training of the model responsive to the accuracy of the model satisfying a predetermined threshold. In some implementations, to extract the weight values from the one or more bottleneck neurons, the system can store the weight values in one or more data structures in memory of the data processing system. In some implementations, the one or more lens functions comprise one or more bias values. In some implementations, to extract the weight values from the one or more bottleneck neurons, the system can extract one or more bias values from the bottleneck neurons.

In some implementations, to extract the weight values from the one or more bottleneck neurons, the system can extract additional weight values from at least one layer following the bottleneck layer. In some implementations, the system can generate the one or more lens functions further based on the additional weight values extracted from the at least one layer following the bottleneck layer. In some implementations, the system can calculate segmentation information for unlabeled data using the one or more lens functions.

### B. Computing and Network Environment

Various operations described herein can be implemented on computer systems. FIG. 9 shows a simplified block diagram of a representative server system 900, client computer system 914, and network 926 usable to implement certain embodiments of the present disclosure. In various embodiments, server system 900 or similar systems can implement services or servers described herein or portions thereof. Client computer system 914 or similar systems can implement clients described herein. The system 500 described herein can be similar to the server system 900. Server system 900 can have a modular design that incorporates a number of modules 902 (e.g., blades in a blade server embodiment); while two modules 902 are shown, any number can be provided. Each module 9s02 can include processing unit(s) 904 and local storage 906.

Processing unit(s) 904 can include a single processor, which can have one or more cores, or multiple processors. In some embodiments, processing unit(s) 904 can include a general-purpose primary processor as well as one or more special-purpose co-processors such as graphics processors, digital signal processors, or the like. In some embodiments, some or all processing units 904 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 904 can execute instructions stored in local storage 906. Any type of processors in any combination can be included in processing unit(s) 904.

Local storage 906 can include volatile storage media (e.g., DRAM, SRAM, SDRAM, or the like) and/or non-volatile storage media (e.g., magnetic or optical disk, flash memory, or the like). Storage media incorporated in local storage 906 can be fixed, removable or upgradeable as desired. Local storage 906 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 904 need at runtime. The ROM can store static data and instructions that are needed by processing unit(s) 904. The permanent storage device can be a non-volatile read-and-write memory device that can store instructions and data even when module 902 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 906 can store one or more software programs to be executed by processing unit(s) 904, such as an operating system and/or programs implementing various server functions such as functions of the system 500 of FIG. 5 or any other system described herein, or any other server(s) associated with system 500 or any other system described herein.

“Software” refers generally to sequences of instructions that, when executed by processing unit(s) 904 cause server system 900 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 904. Software can be implemented as a single program or a collection of separate programs or program modules that interact as desired. From local storage 906 (or non-local storage described below), processing unit(s) 904 can retrieve program instructions to execute and data to process in order to execute various operations described above.

In some server systems 900, multiple modules 902 can be interconnected via a bus or other interconnect 908, forming a local area network that supports communication between modules 902 and other components of server system 900. Interconnect 908 can be implemented using various technologies including server racks, hubs, routers, etc.

A wide area network (WAN) interface 910 can provide data communication capability between the local area network (interconnect 908) and the network 926, such as the Internet. Technologies can be used, including wired (e.g., Ethernet, IEEE 802.3 standards) and/or wireless technologies (e.g., Wi-Fi, IEEE 802.11 standards).

In some embodiments, local storage 906 is intended to provide working memory for processing unit(s) 904, providing fast access to programs and/or data to be processed while reducing traffic on interconnect 908. Storage for larger quantities of data can be provided on the local area network by one or more mass storage subsystems 912 that can be connected to interconnect 908. Mass storage subsystem 912 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 912. In some embodiments, additional data storage resources may be accessible via WAN interface 910 (potentially with increased latency).

Server system 900 can operate in response to requests received via WAN interface 910. For example, one of modules 902 can implement a supervisory function and assign discrete tasks to other modules 902 in response to received requests. Work allocation techniques can be used. As requests are processed, results can be returned to the requester via WAN interface 910. Such operation can generally be automated. Further, in some embodiments, WAN interface 910 can connect multiple server systems 900 to each other, providing scalable systems capable of managing high volumes of activity. Other techniques for managing server systems and server farms (collections of server systems that cooperate) can be used, including dynamic resource allocation and reallocation.

Server system 900 can interact with various user-owned or user-operated devices via a wide-area network such as the Internet. An example of a user-operated device is shown in FIG. 9 as client computing system 914. Client computing system 914 can be implemented, for example, as a consumer device such as a smartphone, other mobile phone, tablet computer, wearable computing device (e.g., smart watch, eyeglasses), desktop computer, laptop computer, and so on.

For example, client computing system 914 can communicate via WAN interface 910. Client computing system 914 can include computer components such as processing unit(s) 916, storage device 918, network interface 920, user input device 922, and user output device 924. Client computing system 914 can be a computing device implemented in a variety of form factors, such as a desktop computer, laptop computer, tablet computer, smartphone, other mobile computing device, wearable computing device, or the like.

Processor 916 and storage device 918 can be similar to processing unit(s) 904 and local storage 906 described above. Suitable devices can be selected based on the demands to be placed on client computing system 914; for example, client computing system 914 can be implemented as a “thin” client with limited processing capability or as a high-powered computing device. Client computing system 914 can be provisioned with program code executable by processing unit(s) 916 to enable various interactions with server system 900.

Network interface 920 can provide a connection to the network 926, such as a wide area network (e.g., the Internet) to which WAN interface 910 of server system 900 is also connected. In various embodiments, network interface 920 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 922 can include any device (or devices) via which a user can provide signals to client computing system 914; client computing system 914 can interpret the signals as indicative of particular user requests or information. In various embodiments, user input device 922 can include any or all of a keyboard, touch pad, touch screen, mouse or other pointing device, scroll wheel, click wheel, dial, button, switch, keypad, microphone, and so on.

User output device 924 can include any device via which client computing system 914 can provide information to a user. For example, user output device 924 can include a display to display images generated by or delivered to client computing system 914. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that functions as both input and output device. In some embodiments, other user output devices 924 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 904 and 916 can provide various functionality for server system 900 and client computing system 914, including any of the functionality described herein as being performed by a server or client, or other functionality.

It will be appreciated that server system 900 and client computing system 914 are illustrative and that variations and modifications are possible. Computer systems used in connection with embodiments of the present disclosure can have other capabilities not specifically described here. Further, while server system 900 and client computing system 914 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the data processing system 505 could be a single module, a logic device having one or more processing modules, or one or more servers.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for generating a lens function using supervised learning techniques, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

Thus, although the disclosure has been described with respect to specific embodiments, it will be appreciated that the disclosure is intended to cover all modifications and equivalents within the scope of the following claims.

What is claimed is:

1. A method, comprising:
maintaining, by a data processing system, labeled training data having a first dimensionality;
training, by the data processing system, using a supervised learning technique and the labeled training data, a model comprising a plurality of layers, the plurality of layers including an input layer having the first dimensionality and a bottleneck layer having one or more bottleneck neurons;
extracting, by the data processing system, responsive to training the model, weight values from the one or more bottleneck neurons;
generating, by the data processing system, one or more lens functions based on the weight values extracted from the one or more bottleneck neurons; and
calculating, by the data processing system, segmentation information for unlabeled data using the one or more lens functions.

2. The method of claim 1, further comprising
storing, by the data processing system, in one or more data structures, a mapping between the unlabeled data and the segmentation information; and
generating, by the data processing system, a directed graph using the mapping between the unlabeled data and the segmentation information.

3. The method of claim 2, wherein generating the directed graph further comprises applying a clustering algorithm to segmentation information to indicate relationships between groups of the unlabeled data.

4. The method of claim 1, wherein training the model further comprises updating, by the one or more processors, the plurality of layers based on a backpropagation algorithm.

5. The method of claim 1, wherein training the model further comprises:
determining, by the data processing system, an accuracy of the model; and
terminating, by the data processing system, training of the model responsive to the accuracy of the model satisfying a predetermined threshold.

6. The method of claim 1, wherein extracting the weight values from the one or more bottleneck neurons further comprises storing, by the one or more processors, the weight values in one or more data structures in memory of the data processing system.

7. The method of claim 1, wherein the one or more lens functions comprise one or more bias values, and wherein extracting the weight values from the one or more bottleneck neurons further comprises extracting, by the data processing system, one or more bias values from the bottleneck neurons.

8. The method of claim 1, wherein extracting the weight values from the one or more bottleneck neurons further comprises extracting additional weight values from at least one layer following the bottleneck layer.

9. The method of claim 8, wherein generating the one or more lens functions is based on the additional weight values extracted from the at least one layer following the bottleneck layer.

10. A method, comprising:
maintaining, by one or more processors coupled to memory, one or more lens functions generated based on weight values extracted from a model trained using a supervised learning technique;
receiving, by the one or more processors, unlabeled data for use in an unsupervised learning technique; and
calculating, by the one or more processors, segmentation information for the unlabeled data.

11. The method of claim 10, further comprising:
storing, by the one or more processors, in one or more data structures, a mapping between the unlabeled data and the segmentation information; and
generating, by the one or more processors, a directed graph using the mapping between the unlabeled data and the segmentation information.

12. The method of claim 11, wherein generating the directed graph further comprises applying a clustering algorithm to segmentation information to indicate relationships between groups of the unlabeled data.

13. A method, comprising:
maintaining, by a data processing system, labeled training data having a first dimensionality;
training, by the data processing system, using a supervised learning technique and the labeled training data, a model comprising a plurality of layers, the plurality of layers including an input layer having the first dimensionality and a bottleneck layer having one or more bottleneck neurons;
extracting, by the data processing system, responsive to training the model, weight values from the one or more bottleneck neurons; and
generating, by the data processing system, one or more lens functions based on the weight values extracted from the one or more bottleneck neurons.

14. The method of claim 13, wherein training the model further comprises updating, by the one or more processors, the plurality of layers based on a backpropagation algorithm.

15. The method of claim 13, wherein training the model further comprises:
determining, by the data processing system, an accuracy of the model; and
terminating, by the data processing system, training of the model responsive to the accuracy of the model satisfying a predetermined threshold.

16. The method of claim 13, wherein extracting the weight values from the one or more bottleneck neurons further comprises storing, by the one or more processors, the weight values in one or more data structures in memory of the data processing system.

17. The method of claim 13, wherein the one or more lens functions comprise one or more bias values, and wherein extracting the weight values from the one or more bottleneck neurons further comprises extracting, by the data processing system, one or more bias values from the bottleneck neurons.

18. The method of claim 13, wherein extracting the weight values from the one or more bottleneck neurons further comprises extracting additional weight values from at least one layer following the bottleneck layer.

19. The method of claim 18, wherein generating the one or more lens functions is based on the additional weight values extracted from the at least one layer following the bottleneck layer.

20. The method of claim 13, further comprising calculating, by the data processing system, segmentation information for unlabeled data using the one or more lens functions.

21. A system, comprising:
a data processing system comprising one or more processors coupled to memory, the data processing system configured to:
maintain labeled training data having a first dimensionality;
train, using a supervised learning technique and the labeled training data, a model comprising a plurality of layers, the plurality of layers including an input layer having the first dimensionality and a bottleneck layer having one or more bottleneck neurons;
extract, responsive to training the model, weight values from the one or more bottleneck neurons;
generate one or more lens functions based on the weight values extracted from the one or more bottleneck neurons; and
calculate segmentation information for unlabeled data using the one or more lens functions.

22. The system of claim 21, wherein the data processing system is further configured to:
store, in one or more data structures, a mapping between the unlabeled data and the segmentation information; and
generate a directed graph using the mapping between the unlabeled data and the segmentation information.

23. The system of claim 22, wherein to generate the directed graph, the data processing system is further configured to apply a clustering algorithm to segmentation information to indicate relationships between groups of the unlabeled data.

24. The system of claim 21, wherein to train the model, the data processing system is further configured to update the plurality of layers based on a backpropagation algorithm.

25. The system of claim 21, wherein to train the model, the data processing system is further configured to:
determine an accuracy of the model; and
terminate training of the model responsive to the accuracy of the model satisfying a predetermined threshold.

26. The system of claim 21, wherein to extract the weight values from the one or more bottleneck neurons, the data processing system is further configured to store the weight values in one or more data structures in memory of the data processing system.

27. The system of claim 21, wherein the one or more lens functions comprise one or more bias values, and wherein to extract the weight values from the one or more bottleneck neurons, the data processing system is further configured to extract one or more bias values from the bottleneck neurons.

28. The system of claim 21, wherein to extract the weight values from the one or more bottleneck neurons, the data processing system is further configured to extract additional weight values from at least one layer following the bottleneck layer.

29. The system of claim 28, wherein the data processing system is further configured to generate the one or more lens functions further based on the additional weight values extracted from the at least one layer following the bottleneck layer.

30. A system, comprising:
one or more processors coupled to memory, the one or more processors configured to:
maintain one or more lens functions generated based on weight values extracted from a model trained using a supervised learning technique;
receive unlabeled data for use in an unsupervised learning technique; and
calculate segmentation information for the unlabeled data.

31. The system of claim 30, wherein the one or more processors are further configured to:
store, in one or more data structures, a mapping between the unlabeled data and the segmentation information; and
generate a directed graph using the mapping between the unlabeled data and the segmentation information.

32. The system of claim 31, wherein to generate the directed graph, the one or more processors are further configured to apply a clustering algorithm to segmentation information to indicate relationships between groups of the unlabeled data.

33. A system, comprising:
a data processing system comprising one or more processors coupled to memory, the data processing system configured to:
maintain labeled training data having a first dimensionality;
train, using a supervised learning technique and the labeled training data, a model comprising a plurality of layers, the plurality of layers including an input layer having the first dimensionality and a bottleneck layer having one or more bottleneck neurons;
extract, responsive to training the model, weight values from the one or more bottleneck neurons; and
generate one or more lens functions based on the weight values extracted from the one or more bottleneck neurons.

34. The system of claim 33, wherein to train the model, the data processing system is further configured to update the plurality of layers based on a backpropagation algorithm.

35. The system of claim 33, wherein to train the model, the data processing system is further configured to:
determine an accuracy of the model; and
terminate training of the model responsive to the accuracy of the model satisfying a predetermined threshold.

36. The system of claim 33, wherein to extract the weight values from the one or more bottleneck neurons, the data processing system is further configured to store the weight values in one or more data structures in memory of the data processing system.

37. The system of claim 33, wherein the one or more lens functions comprise one or more bias values, and wherein to extract the weight values from the one or more bottleneck neurons, the data processing system is further configured to extract one or more bias values from the bottleneck neurons.

38. The system of claim 33, wherein to extract the weight values from the one or more bottleneck neurons, the data processing system is further configured to extract additional weight values from at least one layer following the bottleneck layer.

39. The system of claim 38, wherein the data processing system is further configured to generate the one or more lens functions further based on the additional weight values extracted from the at least one layer following the bottleneck layer.

40. The system of claim 33, wherein the data processing system is further configured to calculate segmentation information for unlabeled data using the one or more lens functions.
